(19) United States
(12) Patent Application Publication
(10) Pub. No.: US 2024/0375600 A1
(43) Pub. Date: Nov. 14, 2024

(54) BUMPER WITH SELECTIVELY ATTACHABLE LIGHT BARS

(71) Applicant: Deist Industries, Inc., Hadley, PA (US)

(72) Inventors: Brody RODGERS, Harrisville, PA (US); Allen FROST, Linesville, PA (US); Jeff BURNS, Waterford, PA (US)

(21) Appl. No.: 18/782,232

(22) Filed: Jul. 24, 2024

Related U.S. Application Data
(63) Continuation of application No. 17/893,339, filed on Aug. 23, 2022, now Pat. No. 12,054,115.
Application No. 17/893,339 is a continuation of application No. 17/222,338, filed on Apr. 5, 2021, now Pat. No. 11,433,837.

(51) Int. Cl. B60R 19/50; B60D 1/52; B60D 1/58

(52) U.S. Cl. CPC B60R 19/50; B60D 1/52; B60D 1/58; B60R 2019/505

(57) ABSTRACT

A vehicle bumper may include a main bumper having first and second light bar mounting surfaces, a first light bar designed to receive and mount at least one light, and a second light bar designed to receive and mount at least one light. The first light bar may be selectively attachable to the first light bar mounting surface and the second light bar may be selectively attachable to the second light bar mounting surface. The vehicle bumper complies with established safety standards for a vehicle bumper.

### I. BACKGROUND

This application is a continuation of U.S. patent application Ser. No. 17/893,339, filed Aug. 23, 2022, which is a continuation of U.S. patent application Ser. No. 17/222,338, filed Apr. 5, 2021 (Now U.S. Pat. No. 11,433,837), the contents of which are incorporated herein by reference.

### A. Technical Field

The present invention pertains to the field of bumpers for vehicles. In particular, the present invention relates to the field of customizable bumpers that can be selectively configured by an end user to suit the specific needs of a truck.

### B. Description of Related Art

Trucks are typically sold with standard factory components such as bumpers, and can include option packages with additional components that can enable certain specific functions suited to the needs of the end user. However, there are a myriad of specific needs for a variety of different end users. Factory standards and options cannot meet every specific user's needs. There is a market for vehicle customization to accommodate these various needs in which modified components can be provided to improve performance of a vehicle and provide functions not available in standard or optional factory components.

Customizing operations can require personnel to adapt and fabricate their own components for use with a bumper. This can be time consuming and material-intensive and thus expensive to the end user. Also such fabricated components do not necessarily comply with established safety standards. This can result in potential liability in the event of the failure of a component. Moreover, customizing operations often result in a monolithic component that is made for the specific needs at the time of the customer ordering the component. Thus, such components usually cannot be subsequently modified to accommodate any additional changing needs of the end user.

Another problem arises with detachable components that can be attached to a customizable bumper. Such components can be supported by a series of bolts in which a first worker supports the components for alignment against the bumper while a second worker inserts the bolts into the aligned holes. This can be a two-worker procedure and can result in difficulty in aligning the components and also difficulty in inserting the bolts while maintaining alignment.

### II. SUMMARY

According to some embodiments of this invention, a vehicle bumper may include a main bumper having first and second light bar mounting surfaces; a first light bar designed to receive and mount at least one light; and a second light bar designed to receive and mount at least one light. The first light bar may be selectively attachable to the first light bar mounting surface and the second light bar may be selectively attachable to the second light bar mounting surface. The vehicle bumper complies with established safety standards for a vehicle bumper.

According to some embodiments of this invention, a vehicle bumper method may include the following steps: A) providing a vehicle bumper having: 1) a main bumper having first and second light bar mounting surfaces; 2) a first light bar designed to receive and mount at least one light; and 3) a second light bar designed to receive and mount at least one light; B) designing the first light bar to be selectively attachable to the first light bar mounting surface; C) designing the second light bar to be selectively attachable to the second light bar mounting surface; and D) designing the vehicle bumper to comply with established safety standards for a vehicle bumper.

According to some embodiments of this invention, a replacement vehicle bumper may be used with an associated vehicle having an original bumper. The replacement vehicle bumper may include: a main bumper having first and second light bar mounting surfaces; a first light bar designed to receive and mount at least one light; and a second light bar designed to receive and mount at least one light. The first light bar may be selectively attachable to the first light bar mounting surface and the second light bar may be selectively attachable to the second light bar mounting surface. The replacement vehicle bumper is designed to replace the original bumper.

According to some embodiments of this invention, a vehicle bumper can be customized to accommodate the needs of specific users.

According to some embodiments of this invention, a vehicle bumper improves performance of a vehicle and provides functions not available in standard or optional factory components.

According to some embodiments of this invention, a vehicle bumper can be customized without fabricating or adapting bumper components.

According to some embodiments of this invention, a vehicle bumper can be customized without the expense associated with a time consuming and material-intensive fabricating process.

According to some embodiments of this invention, a customizable vehicle bumper can be subsequently modified to accommodate any changing needs of the end user.

Other benefits and advantages of this invention will become apparent to those skilled in the art to which it pertains upon reading and understanding of the following detailed specification.

### III. BRIEF DESCRIPTION OF THE DRAWINGS

The disclosed vehicle bumper may take physical form in certain parts and arrangement of parts, embodiments of which will be described in detail in this specification and illustrated in the accompanying drawings which form a part hereof and wherein:

FIG. 1 is a perspective view of the vehicle bumper in accordance with an exemplary embodiment of the present invention.

FIG. 2 is a frontal view of the vehicle bumper in accordance with the exemplary embodiment of the present invention.

FIG. 3 is a top view of the vehicle bumper in accordance with the exemplary embodiment of the present invention.

FIG. 4 is a perspective view of the vehicle bumper in accordance with an alternate exemplary embodiment of the present invention.

FIG. 5 is a frontal view of the vehicle bumper in accordance with the alternate exemplary embodiment of the present invention.

FIG. 6 is a perspective view of the elongated body portion with mounting plate of the vehicle bumper in accordance with the present invention.

FIG. 7 is a frontal view of the elongated body portion with mounting plate of the vehicle bumper in accordance with the present invention.

FIG. 8 is a side view of the elongated body portion with mounting plate of the vehicle bumper in accordance with the present invention.

### IV. DETAILED DESCRIPTION

Referring now to the drawings wherein the showings are for purposes of illustrating embodiments of the article only and not for purposes of limiting the same, and wherein like reference numerals are understood to refer to like components:

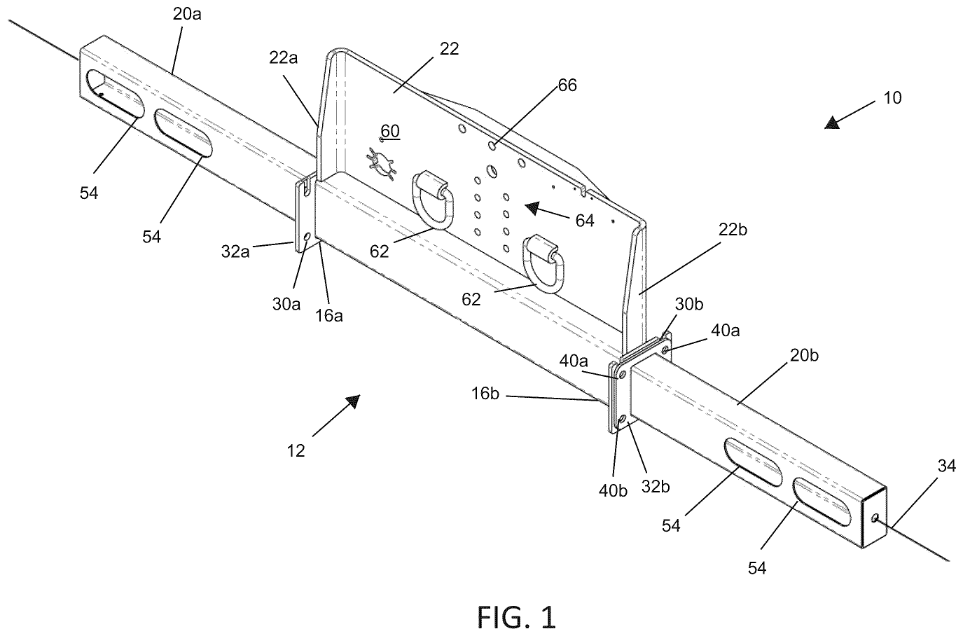

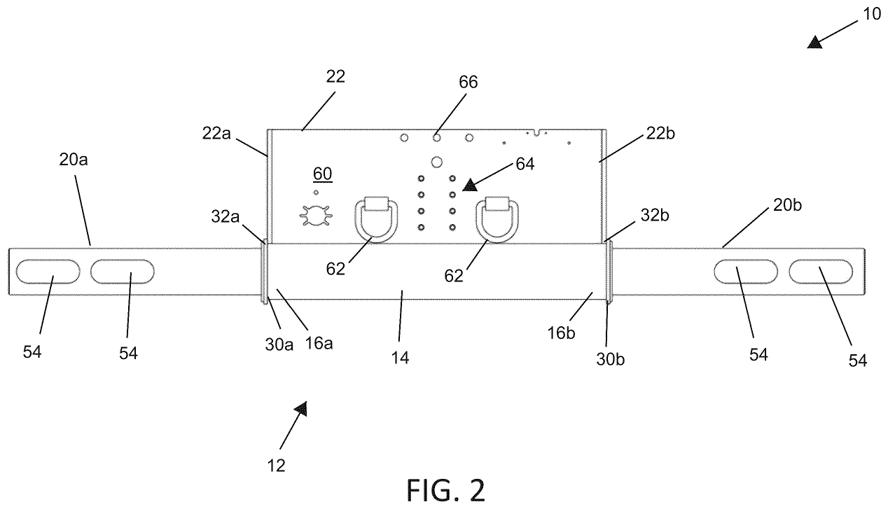

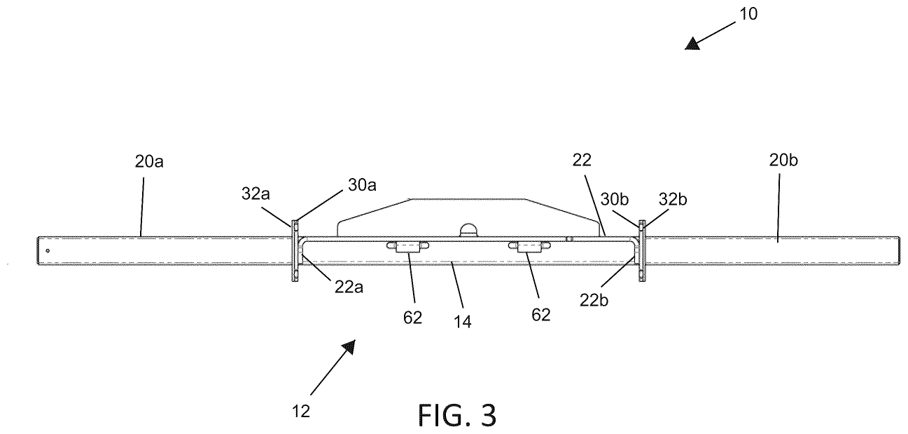

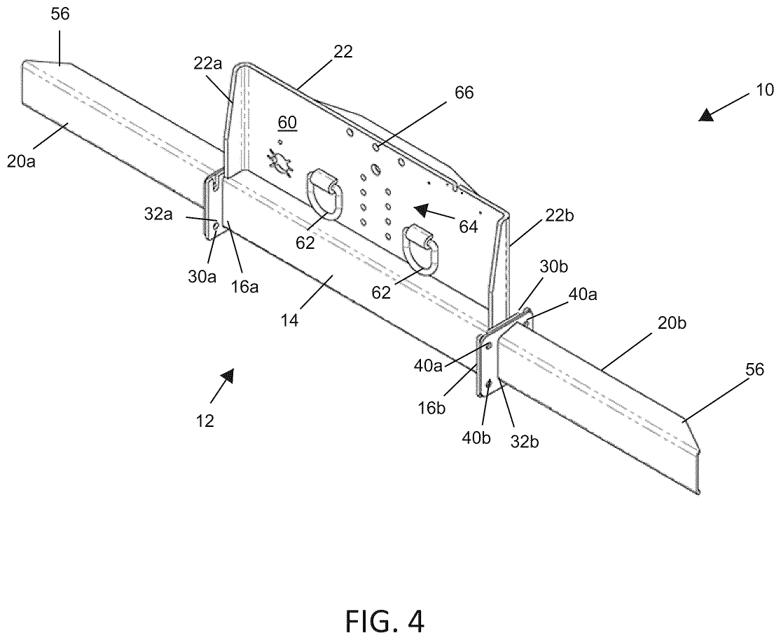

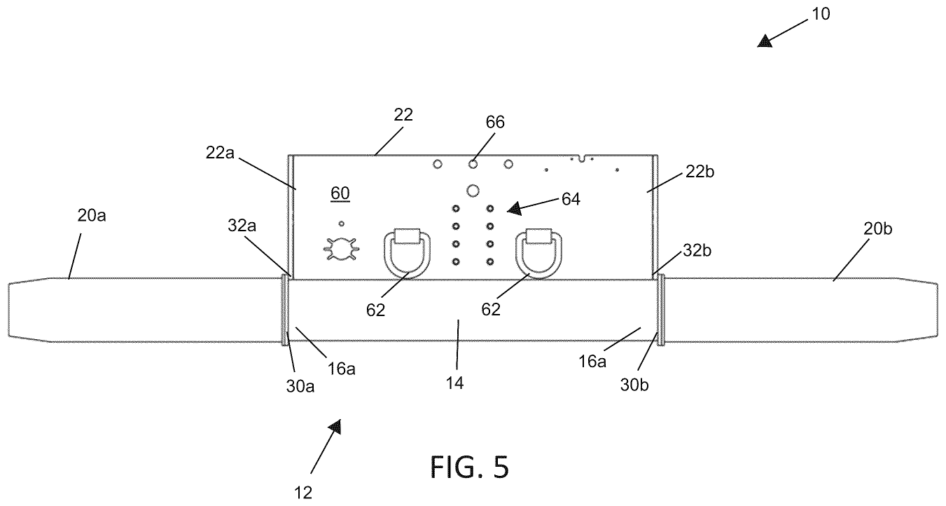

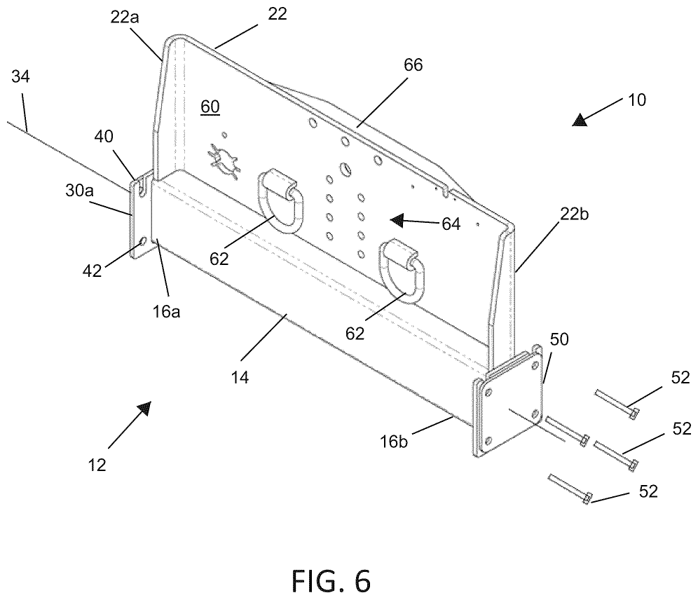

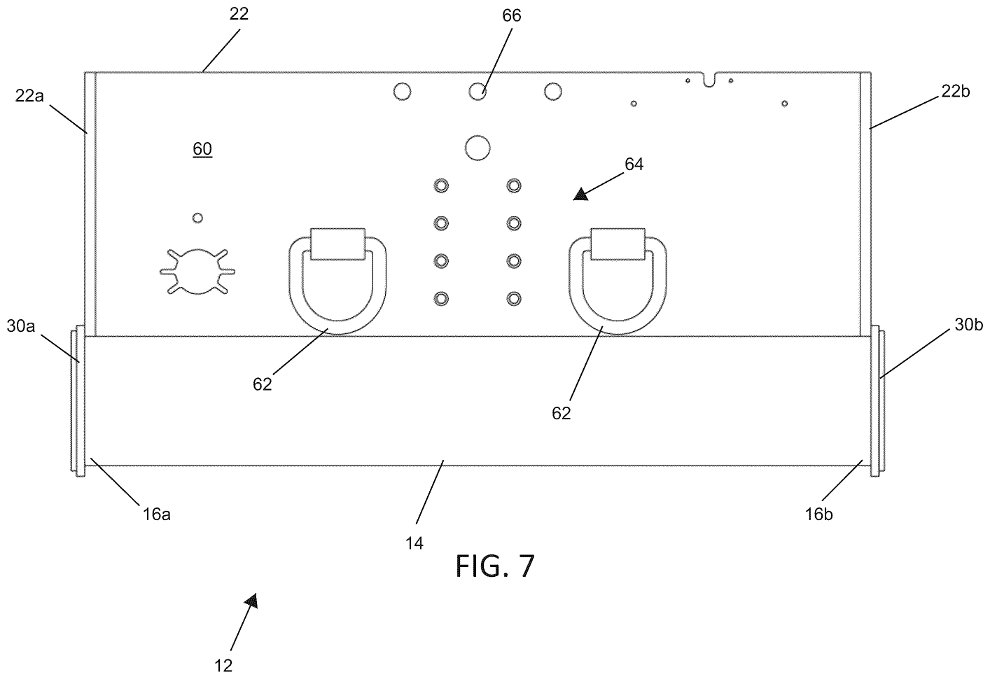

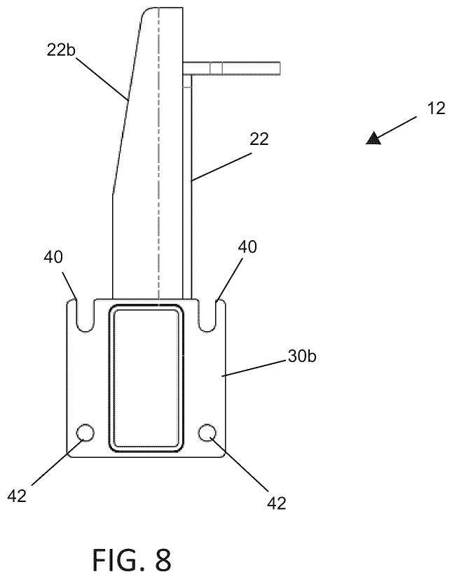

FIGS. 1, 2, and 3 depict the vehicle bumper 10 in accordance with an exemplary embodiment. FIGS. 4 and 5 depict the vehicle bumper 10 in accordance with an alternate exemplary embodiment. In both embodiments, the bumper 10 includes a main bumper 12 having an elongated body portion 14 with a first end 16a and a second end 16b. The vehicle bumper 10 also includes a first detachable light bar 20a and a second detachable light bar 20b. FIGS. 6, 7, and 8 specifically show the main bumper 12 alone, without the light bars 20a, 20b.

As shown in FIGS. 1-8, both embodiments include a mounting plate 22 formed integrally with the elongated body portion 14 of the main bumper 12. The mounting plate 22 includes a planar mounting surface 60 extending away from the elongated body portion 14. The mounting plate 22 can be integrally formed with the elongated body portion 14 via welding or other suitable type of bonding or other securement. Various additional aspects of the mounting plate 22 will be disclosed in greater detail hereinbelow.

With reference to FIGS. 1-8, particularly FIGS. 6-8, the elongated body portion 14 includes a first mounting flange 30a and a second mounting flange 30b. The first and second mounting flanges 30a, 30b are formed integrally with the respective first and second ends 16a, 16b of the elongated body portion 14. The mounting flanges 30a, 30b can be integrally formed with the elongated body portion 14 via welding or other suitable type of bonding or other securement.

With particular reference to FIGS. 1-5, the first detachable light bar 20a and the second detachable light bar 20b are both detachable from the main bumper 12 and include mating mounting flanges 32a, 32b for attaching to the main bumper 12. The first light bar 20a includes a first mating mounting flange 32a and the second light bar 20b includes a second mating mounting flange 32b. These first and second mating mounting flanges 32a, 32b are configured for detachable engagement with the respective first and second mounting flanges 16a, 16b of the main bumper.

As shown in FIGS. 1-8, particularly FIGS. 6-8, the elongated body portion 14 of the main bumper 12 has a generally rectangular shape and thereby includes a generally rectangular cross section. The first and second mounting flanges 30a, 30b are formed as respective first and second rectangular peripheral portions that are perpendicular to an axis 34 running through the center of the length direction of the elongated body portion 14 and thus the entire vehicle bumper 10. The mating mounting flanges 32a, 32b on the first and second light bars 20a, 20b are similarly formed as respective first and second rectangular peripheral portions that are perpendicular to the axis 34 of the vehicle bumper 10. In this manner the first and second mounting flanges 30a, 30b of the elongated body portion 14 have first and second facing sides that abut first and second facing sides on the respective first and second mating peripheral portions on the respective first and second mating mounting flanges 32a, 32b of the first and second light bars 20a, 20b.

As particularly seen in FIGS. 6-8, apertures are formed at each respective corner of the first and second mounting rectangular peripheral portions of the first and second mounting flanges 30a, 30b. These apertures are formed in the mounting flanges 30a, 30b in order to receive bolts extending through from the respective first and second mating mounting flanges 32a, 32b of the first and second light bars 20a, 20b. While any suitable shape apertures could be formed in the mounting flanges 30a, 30b, in the preferred embodiment the apertures particularly include a pair of slots 40 into which a pair of bolts are slid from the respective first and second mating mounting flanges 32a, 32b. The apertures also include a pair of bolt holes 42 into which another pair of bolts are extended from the respective first and second mating mounting flanges 32a, 32b. In the preferred embodiment, each of the pair of slots 40 are vertical slots formed near the corners inwards from a top edge of the respective mounting flange 30a, 30b, where the “top edge” is the upwardly vertical edge when the bumper is installed in its operative position.

As follows from the FIGS. 1 and 4, the slots 40 greatly facilitate the assembly of the light bars 20a, 20b to the main bumper 12. The mating mounting flanges 32a, 32b of the light bars 20a, 20b each include bore holes for receiving bolts. In operation, two bolts are inserted into the two top bore holes 40a formed along the top edge of the mating mounting flanges 32a, 32b. When the light bars 20a, 20b are abutted to the main bumper 12, the bolts are then readily dropped into the vertical slots 40 of the mounting flanges 16a, 16b, so that the mating mounting flanges 32a, 32b are readily aligned with the mounting flanges 30a, 30b. The bolts can then be secured with suitable nuts to hold the light bars 20a, 20b in place against the main bumper 12. Afterwards, two more bolts can be inserted into the two bottom bore holes 40b formed along the bottom edge of the mating mounting flanges 32a, 32b, which are already aligned with the mounting flanges 30a, 30b, and are then readily secured with nuts. Thus, the vertical slots 40 facilitate and simplify a light bar assembly operation, which can be performed by one person instead of requiring one person to hold the light bar in alignment with the main bumper while another person inserts bolts in four corner holes.

As indicated in FIG. 6, a customizable bumper design may be contemplated in which one or both light bars 20a, 20b remain detached from the main bumper 12. In this instance, one or both of the first and second mounting flanges 30a, 30b are enclosed by a flat plate 50 for covering the respective flange 30a, 30b if the respective detachable light bar 20a, 20b is detached. The flat plate 50 is secured with bolts 52, which can be the same bolts used to secure the light bar. The flat plate 50 prevents dirt and moisture from entering into the hollow elongated body portion 14.

With reference to FIGS. 1-5, the first and second detachable light bars 20a, 20b can be of any suitable configuration for installing one or more lights to the vehicle bumper 10. In the preferred embodiment the light bars 20a, 20b are elongated members that each extend away from the main bumper 12 along the axis 34 of the elongated body portion 14. As shown particularly in the exemplary embodiment of FIGS. 1-3, one or both of the first and second detachable light bars 20a, 20b include one or more holes 54 for receiving and mounting at least one customizable light to the vehicle bumper 12. As shown particularly in the alternate exemplary embodiment of FIGS. 4 and 5, one or both of the first and second detachable light bars 20a, 20b include a slanted portion 56, formed on the end of the light bars 20a, 20b, where the end of the light bar includes chamfered edges tapered from the front to the back for aesthetics and ergonomic safety.

As generally shown in FIGS. 1-8, the mounting plate 22 includes two angled portions 22a, 22b, perpendicular to the plane of the mounting surface 60 of the mounting plate 22, for providing mechanical strength and secure attachment to the elongated body portion 14. The mounting surface 60 of the mounting plate 22 preferably includes a pair of standard D rings 62 for attaching a trailer safety chain. The mounting surface 60 of the mounting plate 22 also preferably includes an array of mounting holes 64 formed at different positions upon the mounting surface 60 for selectively bolting an interchangeable trailer hitch or pintle type hitch (not shown) onto the bumper at a desired position, enabling a selection of hitch heights and types to suit the needs of the end user. The mounting surface can also include a series of additional holes 66 for mounting any other selected items, such as a license plate or any other accessories.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed:

1. A vehicle bumper comprising:
a main bumper having first and second light bar mounting surfaces;
a first light bar designed to receive and mount at least one light; and
a second light bar designed to receive and mount at least one light;
wherein:
1) the first light bar is selectively attachable to the first light bar mounting surface;
2) the second light bar is selectively attachable to the second light bar mounting surface; and
3) the vehicle bumper complies with established safety standards for a vehicle bumper.

2. The vehicle bumper of claim 1 wherein:
the first light bar mounting surface has a flange defined as a first flange;
the second light bar mounting surface has a flange defined as a second flange;
the first light bar has a flange defined as a third flange;
the second light bar has a flange defined as a fourth flange;
the third flange engages with the first flange to selectively attach the first light bar to the main bumper; and
the fourth flange engages with the second flange to selectively attach the second light bar to the main bumper.

3. The vehicle bumper of claim 1 wherein:
the first light bar mounting surface is positioned on a first end of the main bumper; and
the second light bar mounting surface is positioned on a second end of the main bumper.

4. The vehicle bumper of claim 1 wherein when the first light bar is attached to the first light bar mounting surface and the second light bar is attached to the second light bar mounting surface:
the first and second light bars extend along a common axis.

5. The vehicle bumper of claim 1 wherein:
the vehicle bumper is designed to replace an original bumper on an associated vehicle.

6. The vehicle bumper of claim 1 wherein:
the main bumper has a support member formed integrally with a mounting plate.

7. The vehicle bumper of claim 1 wherein:
the first light bar has a plurality of holes where each hole is designed to receive and mount at least one customizable light; and
the second light bar has a plurality of holes where each hole is designed to receive and mount at least one customizable light.

8. The vehicle bumper of claim 1 wherein the main bumper has a component mounting surface having:
an array of mounting holes for use in attaching an associated first component to the vehicle bumper; and
a pair of D rings for use in attaching an associated second component to the vehicle bumper.

9. A vehicle bumper method comprising the steps of:
A) providing a vehicle bumper having:
1) a main bumper having first and second light bar mounting surfaces;
2) a first light bar designed to receive and mount at least one light; and
3) a second light bar designed to receive and mount at least one light;
B) designing the first light bar to be selectively attachable to the first light bar mounting surface;
C) designing the second light bar to be selectively attachable to the second light bar mounting surface; and
D) designing the vehicle bumper to comply with established safety standards for a vehicle bumper.

10. The vehicle bumper method of claim 9 further comprising the steps of:
designing the first light bar to be selectively detachable from the first light bar mounting surface; and
designing the second light bar to be selectively detachable from the second light bar mounting surface.

11. The vehicle bumper method of claim 9 wherein step A comprises the step of:
providing the main bumper with a support member formed integrally with a mounting plate.

12. The vehicle bumper method of claim 9 wherein:
step A comprises the steps of:
1) providing the first light bar mounting surface with a flange defined as a first flange;
2) providing the second light bar mounting surface with a flange defined as a second flange;
3) providing the first light bar with a flange defined as a third flange; and
4) providing the second light bar with a flange defined as a fourth flange;
step B comprises the step of: engaging the third flange with the first flange to selectively attach the first light bar to the main bumper; and
step C comprises the step of: engaging the fourth flange with the second flange to selectively attach the second light bar to the main bumper.

13. The vehicle bumper method of claim 9 further comprising the step of:
designing the vehicle bumper to replace an original bumper on an associated vehicle.

14. The vehicle bumper method of claim 9 wherein:
step A comprises the step of: providing the main bumper with a component mounting surface having an array of mounting holes and a pair of D rings; and
the method further comprises the steps of:
1) designing the array of mounting holes for use in attaching an associated first component to the vehicle bumper; and
2) designing the D rings for use in attaching an associated second component to the vehicle bumper.

15. The vehicle bumper method of claim 9 wherein:
step A comprises the steps of:
1) providing the first light bar with a plurality of holes; and
2) providing the second light bar with a plurality of holes; and
the method further comprises the step of: designing each hole in the first light bar and in the second light bar to receive and mount at least one customizable light.

16. A replacement vehicle bumper for use with an associated vehicle having an original bumper, the replacement vehicle bumper comprising:
a main bumper having first and second light bar mounting surfaces;
a first light bar designed to receive and mount at least one light; and
a second light bar designed to receive and mount at least one light;
wherein:
1) the first light bar is selectively attachable to the first light bar mounting surface;
2) the second light bar is selectively attachable to the second light bar mounting surface; and
3) the replacement vehicle bumper is designed to replace the original bumper.

17. The replacement vehicle bumper of claim 16 wherein:
the main bumper has a support member formed integrally with a mounting plate.

18. The replacement vehicle bumper of claim 16 wherein:
the first light bar mounting surface has a flange defined as a first flange;
the second light bar mounting surface has a flange defined as a second flange;
the first light bar has a flange defined as a third flange;
the second light bar has a flange defined as a fourth flange;
the third flange engages with the first flange to selectively attach the first light bar to the main bumper; and
the fourth flange engages with the second flange to selectively attach the second light bar to the main bumper.

19. The replacement vehicle bumper of claim 16 wherein:
the first light bar has a plurality of holes where each hole is designed to receive and mount at least one customizable light; and
the second light bar has a plurality of holes where each hole is designed to receive and mount at least one customizable light.

20. The replacement vehicle bumper of claim 16 wherein the main bumper has a component mounting surface having:
an array of mounting holes for use in attaching an associated first component to the vehicle bumper, and
a pair of D rings for use in attaching an associated second component to the vehicle bumper.
